(19) United States
(12) Patent Application Publication
(10) Pub. No.: US 2001/0048445 A1
(43) Pub. Date: Dec. 6, 2001

(54) Image display system

(76) Inventor: Hidenori Ikeno, Tokyo (JP)

Correspondence Address: McGuire Woods, Suite 1800, Tysons Corner, 1750 Tysons Boulevard, McLean, VA, 22102-4215, US

(21) Appl. No.: 09/863,433

(22) Filed: May 24, 2001

(30) Foreign Application Priority Data
May 25, 2000 (JP) 155048/2000

(51) Int. Cl. G09G 5/02

(52) U.S. Cl. 345/589

(57) ABSTRACT

At least of images to be reconstituted, a display controller 5 separates gradation data constituting image data and image quality data of the images to be reconstituted, and transmits the two different separated data together with such data as layer data and active area data concerning display areas to an image display unit. In the image display unit, gamma coefficient data of the full display area is determined from the obtained gradation data and image quality data by using first layer data. As for a 2-nd to an n-th layer image, image correction is made via a color managing image processor to obtain satisfactory image quality with first layer correction coefficient data, thus minimizing the image quality deterioration in the full display area. Thus, a system permits image reproduction faithful to the image quality of the original images.

### BACKGROUND OF THE INVENTION

This application claims benefit of Japanese Patent Application No. 2000-155048 filed on May 25, 2000, the contents of which are incorporated by the reference.

The present invention relates to image display systems, for example, to image display systems for displaying image data transmitted from an image drawing unit to an image display unit.

A prior art electronic image display system (hereinafter referred to as “image display system”) will now be described with reference to FIG. 6. In personal computers and like computer systems, an image display unit 2 or like display is indispensable as man-machine interface.

In such a computer system, a CRT (i.e., cathode-ray tube) monitor or the like is usually used as image display device 9 for displaying image. In this system, an image drawing unit 1 and an image display unit 2 are interconnected by two independent communication cable lines 10 and 11 for transmitting image data and image display timing data, respectively, from the unit 1 to the unit 2.

As the communication cable line 10 for transmitting the image data, one cable is allotted to each of three primary colors (i.e. red, green and blue). The image data signal that is transmitted on this line 10 is an amplitude modulated analog signal of amplitude width 1 vp-p.

As the communication cable line 11 for transmitting sync signals that are necessary for displaying the image data, two cables are used for a vertical and a horizontal sync signal, respectively.

The image data 3 which is generated by an electronic still camera or image processing software and recorded as electronic data in a recording medium or the like, is fed out via an operational processor 4 to a display controller 5 to generate a video signal.

As for the operational processor 4, various source images may be developed on the same display screen by such means as software for supporting a graphic user interface (GUI) system. In this case, image data 3 of various original images are mixed in the operational processor 4 and then fed out to the display controller 5, which in turn outputs video signal.

The display controller 5 executes separation of the three primary colors of red, green and blue (RGB) from the original image data fed out from the operational processor 4, separation of the image data and the sync data representing image display timing to be informed to the image display unit 2, and signal conversion for luster scanning. The RGB image data are sent out to the image data transmission communication cable line 10, and the sync signal is sent out to the sync signal transmission communication cable line 11.

The image display unit 2 can not actually display the direct image data sent out via the image data transmission communication cable line 10, and therefore it executes signal amplification and gamma correction in conformity to a light intensity versus voltage characteristic of the image display device 9.

At this time, a relation between the gradation characteristic of the input image data and the light intensity versus voltage characteristic of the image display device 9 is given as gamma correction coefficient data from a gamma correction coefficient circuit 7 to gamma correction circuit 6 (the two circuits being possibly integrated).

Gamma corrected image data from the gamma correction circuit 6 and the sync data sent out on the communication cable line 11, are inputted to a display control circuit 8 for conversion to a signal for driving the image display device 9. In this way, image is displayed on the image display device 9.

In many of the image display units 2, the display control circuit 8 has a mechanism of finely adjusting the contrast ratio and the brightness of the displayed images.

In the prior art image display system shown in FIG. 6, the images are displayed through the stage as described above. From a signal flow check, it is seen that in the case of FIG. 6 only gradation data of image is supplied from the image data 3.

Through the following operational processor 4 and display controller 5, the gradation data is converted in the expression form, and in the processing in the gamma correction circuit 6 it is given image quality data such as the contrast and brightness of the actual data expressed on the image display device 9.

Thus, it will be seen that the data that is preserved until actual display of the original image data 3 on the image display device 9 is the sole gradation data of image. That is, image quality data representing the contrast ratio, the gamma characteristic and the necessary brightness which are presumed when generating the gradation data 3 are missing.

As shown, in the prior art image display system, sine the sole gradation data of image is preserved until actual display of the original image data 3 on the image display device 9, no image quality determining factor is considered in any stage.

Particularly, the image display unit 2 allows user's intervention (i.e., setting operation) concerning parameters relevant to the image quality such as the contrast and the brightness, and the color temperature in some cases. This means that in the prior art image display system the images displayed on the image display device may not be faithful replica of images when the image data 3 is generated.

In addition, since the image quality data is provided to the image display unit 2, in the display of various still and motion picture images in a simultaneous or a switching fashion, all the original images supplied as the image data 3 may not be generated with the same image quality parameters.

Therefore, in the image switching mode it is impossible to obtain faithful reproduction of required display characteristics of all original images.

For example, in the personal computer image display, high contrast and sharp images are preferred. Therefore, where the characteristics of the personal computer image output are matched to the characteristics of the image display device, such image data 3 as motion picture data assuming linear gamma characteristic results in rather blackish display. In addition, due to excessively high image contrast ratio the displayed image is flat and not readily visible.

In view of the above problems, methods of reproducing original images faithfully inclusive of the image quality, are described in detail in such literatures as Nikkey Bite, pp-152, January 1999. Among these prior art methods is a system, in which display characteristics of an image display unit are preliminarily measured by sensors and informed as data thus generated to an image drawing unit, and image gradation is corrected therein for data output such as to match a gradation characteristic required by the original image. Among the described methods is also an attempt for managing data with software (such as “Integrated Color Management” by Microsoft Co., Ltd.).

In the described methods, however, the gradation characteristic is corrected to linearity, and a sole linear gradation component is extracted and utilized with sacrifice in the number of gradations. Therefore, all the gradations initially held in the image display system can not be utilized. This leads to a problem in the case of displaying image data generated under the full color preamble (i.e., 256 gradations for each of the RGB colors), image quality reduction is possible due to the reduced number of gradations. Another problem is posed by uniform gamma correction over the entire screen area. That is, a problem is encountered in a window type display, which is currently a main fashion of personal computer system display. In the window type display, a display screen is assumed to have an imaginary multi-layer structure, and a number of software displays are distributed to individual layers for display. In this case, optimization is not provided for all the layers.

It is a basic cause of the above problems that in the prior art image no image quality managing mechanism is provided for each signal processing block, so that images are displayed without any reference for each block.

Another basic cause resides in that the values of the contrast, the brightness, the gamma correction characteristic, etc. for determining the image display characteristics on the image display device side are fixed and independent of the input image data, and can not be independently adjusted on the basis of the input image data. Therefore, the image display device side cannot guarantee reproduction of assumed image display characteristics of the original images.

### SUMMARY OF THE INVENTION

The present invention was made on the basis of the recognition of the above problems, and it has an object of providing an image display system, in a mechanism for adjusting image display characteristics as desired such as to match the original image data is provided on the image display device side, thus permitting viewing of various original images without image quality reduction.

According to an aspect of the present invention, there is provided an image display system comprising an image drawing unit and an image display unit for receiving and displaying image data transmitted from the image drawing unit, wherein: the image drawing unit includes means for transmitting image quality data prescribing image display characteristics with respect to the image data to at least the image display unit; and the image display unit includes means for correcting and displaying the image data on the basis of the image quality data transmitted from the image drawing unit.

According to another aspect of the present invention, there is provided an image display system comprising an image drawing unit and an image display unit for receiving and displaying image data transmitted from the image drawing unit, wherein: the image drawing unit includes means for transmitting image quality data prescribing image display characteristics with respect to the image data and image condition designation data for designating the display structure to at least the image display unit; and the image display unit includes means for correcting and displaying the image data on the basis of the image quality data transmitted from the image drawing unit.

The image drawing unit transmits gradation data constituting the image as the image data to the image display unit. Image data dealt with in the image drawing unit includes image data recorded as electronic data or image data of one or more layers generated by predetermined software.

According to other aspect of the present invention, there is provided an image display system comprising an image drawing unit and an image display unit for receiving and displaying image data transmitted from the image drawing unit, wherein: the image drawing unit includes means for separating gradation data, image quality data and display condition designation data concerning images to be reconstituted and transmitting the separated gradation data and display condition designation data to the image display unit, and the image display unit includes means for receiving the gradation data, the image quality data and the image condition designation data and correcting and displaying the images on the basis of the received gradation data, image quality data and display condition designation data.

The image display unit includes means for informing the status of the image display unit to the image drawing unit. The gradation data, the image quality data and the display condition designation data are transmitted via respective transmitting means provided separately from image data transmitting means, or transmits at least two different data among the gradation data, the image quality data, the display condition designation data and the image data via the same transmitting means, to the image display unit. The display condition designation data transmitted from the image drawing unit to the image display unit includes at least data of the number and positions of windows displayed on the screen or layer data. The image quality data transmitted from the image drawing unit to the image display unit includes at least the gamma characteristic data, the color space data or the luminance data of each layer in the display condition designation data. The image display system further comprises: means for updating the gamma correction coefficient of a gamma correction circuit in the image display unit on the basis of the image quality data transmitted from the image drawing unit; and means for correcting a gamma coefficient error by image processing when an image with image quality data different from the gamma correction coefficient preset in the gamma correction circuit is transmitted from the image drawing unit to the image display unit. Image data transmitted from the image drawing unit to the image display unit is displayed by utilizing the full display area, gradation voltage data given to a gradation voltage generator is updated for display with image quality data of the image data transmitted from the image drawing unit; and the image display unit includes means operable, when image data of a plurality of layers are transmitted from the image drawing unit to the image display unit, to generate a gradation voltage with preset gradation voltage data and execute image processing on the image data such as to minimize the error. In the image display unit, gradation voltage data to be given to a gradation voltage generator provided in the image display unit is set on the basis of first layer image quality data irrespective of whether the image data displayed is of a single layer or a plurality of layer; and the image data of the second to an n-th layer (n being an integral number greater than 2) are standardized by image processing scan with the first layer image quality data, thus suppressing the image quality deterioration. The first layer image data transmitted from the image drawing unit to the image display unit is constituted by sole gradation data and when no image quality data is included, the display is made by using image quality data preset in an initial preset data memory in the image display unit. The image drawing unit includes means for causing data transmission from the image drawing unit to the image display unit after making standardization of the gradation characteristics of the second to the n-th layers with the first layer image quality data, thus reducing the amounts of the image quality data and display condition designation data transmitted from the image drawing unit to the image display unit.

According to further aspect of the present invention, there is provided an image display system comprising means for causing transmission of display condition designation data (or “image quality data”) representing contrast, brightness, gamma characteristic, etc. together with gradation data for each image-constituting layer from an image drawing unit to an image display unit, wherein: the correction of the full display area is controlled by using the image quality data of a theoretically outermost layer (or “first layer”) on the screen, while image processing on the images of the layers other than the first layer is done such as to match the first layer image quality data.

According to still further aspect of the present invention, there is provided an image display system for transmitting video signal generated from image data in an image drawing unit to an image display unit, wherein: the image drawing unit includes: means for separating gradation data and image quality data constituting image data; and means for transmitting the gradation data and the image quality data together with a display layer data to the image display unit; and the image display unit includes means for determining a correction coefficient of the full display area from the received gradation data and image quality data by using data of the first layer as theoretically outermost layer on the screen, while causing image correction of the images of a second to an n-th (n being an integral number greater than 2) layer via a color managing image processing means with first layer correction coefficient data, thus suppressing image quality deterioration of the full display area.

Data concerning the layer structure, the gamma characteristic, the contrast, the brightness and the effective image area are transmitted as the image quality data from the image drawing unit to the image display unit. The image display system further comprises: an image quality data processor for executing a process of converting characteristics of an image display device on the basis of each layer input image quality data; the image quality processor obtains a gradation voltage data applied to the image display device on the basis of the image quality data of the first layer as outermost layer; image quality data of the layers other than the outermost layer are transmitted together with the outermost layer image quality data to a color managing image processor; and the color managing image processor executes image processing on the gradation data of images with reference to the first layer, and generates a drive voltage by multiplying the processed data by gradation voltage data obtained from a gradation voltage generator for the display of the data on the image display device.

The image display system further comprises means for transmitting operation status data from the image display unit to the image drawing unit. The image display unit includes an initial preset data memory for setting initial preset data of image data at the power source connection time or at the resetting time, and prescribes gamma correction parameter on a full display area in a gradation voltage generator by using first layer image quality data in image quality data transmitted from the image drawing unit; and when the operation is unstable such as at the power source connection time or at the resetting time, the gamma correction data and color matching mechanism parameter data are set and displayed by using image quality data recorded in the initial preset data memory. The image display unit includes: a fine adjustment data input circuit, in which is stored difference data obtained by comparison of image quality data transmitted from the image drawing unit with data inputted from the fine adjustment data input circuit; and a color managing image processor for executing image processing on image data of a multi-layer configuration transmitted from the image drawing unit with respect to the second to n-th (n being an integral number greater than 2) layers other than the first layer with the transmitted image quality data and difference data stored in the initial preset data memory, whereby satisfactory image quality can be preserved for all the layers.

According to other aspect of the present invention, there is provided an image display system comprising means for predetermining correction coefficient data of the full display area by using data of a first layer as outermost layer on the basis of gradation data and image display characteristic data constituting image data and display-constituting layer data and executing image correction by using the first layer correction coefficient data.

The image quality data includes at least one of data concerning the layer configuration, the gamma characteristic, the contrast, the brightness and the effective image area of an original image.

According to further aspect of the present invention, there is provided an image display system comprising: means for predetermining correction coefficient data of the full display area by using data of a first layer as outermost layer on the basis of gradation data and image display characteristic data constituting image data and display-constituting layer data and executing image correction by using the first layer correction coefficient data; an image quality data processor for executing a process of converting characteristics of an image display device on the basis of image quality layer of each layer and executing conversion to a gradation voltage data given to the image display device on the basis of the outermost layer image quality data; image quality data of the layers other than the outermost layer being transmitted together with the outermost layer image quality data to a color managing image processor, and the color managing image processor executing image processing on the gradation data of images with reference to the first layer, and generating a drive voltage for the display of data on the image display device by multiplying the processed data by gradation voltage data obtained from a gradation voltage generator.

The image display system further comprising an initial preset data memory for setting initial preset data of image data at the power source connection time and at the resetting time, wherein the image display unit prescribes full display area gamma correction parameter data in the gradation voltage generator by using first layer image quality data in the image quality data transmitted from the image drawing unit; and when the operation is unstable such as at the power source connection time and at the resetting time, the gamma correction data and color matching mechanism parameter data in the gradation voltage generator and the color managing image processor are set for image display by using image quality data stored in the initial preset data memory.

Other objects and features will be clarified from the following description with reference to attached drawings.

### BRIEF DESCRIPTION OF THE DRAWINGS

FIG. 1 is a view for describing the basic construction of and the operational principle underlying the first embodiment of the present invention;

FIGS. 2(a) and 2(b) show drawings of a 1-st to an n-th layers formed as imaginary display areas on a display screen;

FIG. 3 is a view showing the construction of the second embodiment of the present invention;

FIG. 4 is a view showing the construction of the third embodiment of the present invention;

FIG. 5 is a view showing the construction of the fifth embodiment of the present invention; and

FIG. 6 shows a prior art electronic image display system.

### PREFERRED EMBODIMENTS OF THE INVENTION

Preferred embodiments of the present invention will now be described with reference to the drawings. The principles underlying the present invention will first be described, and then embodiments thereof will be described in details.

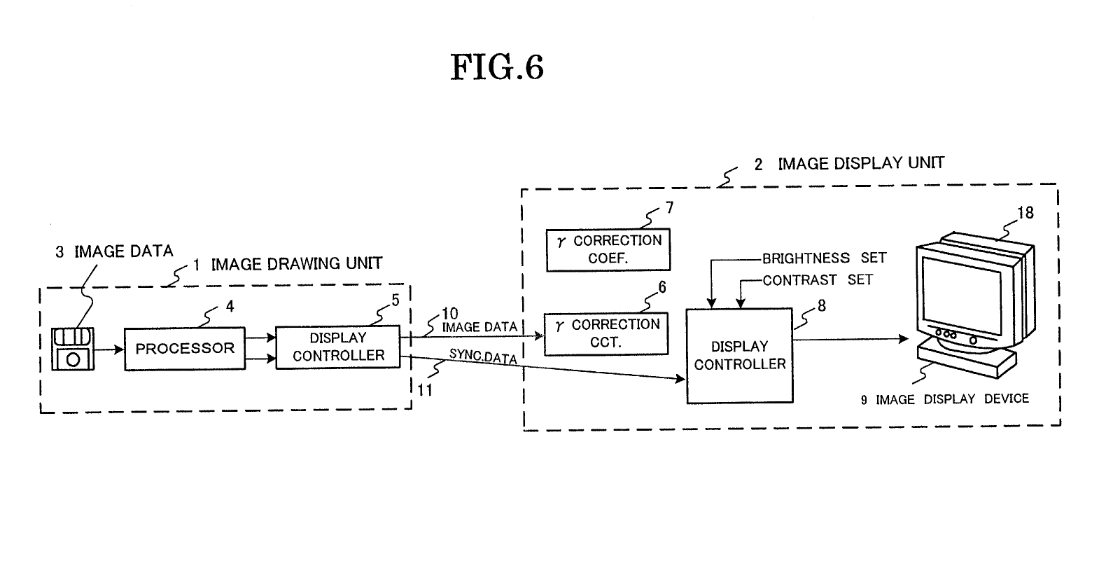

In the prior art image display system shown in FIG. 6, an image different from image data 3 obtained in the circumstance of the original image generation, may be actually displayed in the image display device 9. This is so because in the prior art image display system sole image gradation data is preserved until the image data 3 is fed to the image display device 9.

In addition, in the recent multi-layer display in a personal computer window display system or the like, operations concerning a number of different applications are dealt with on the same screen. Therefore, if correction coefficients of a color management image control mechanism for gamma correction and the like in the image display unit 2 are prescribed for one of the images, the expression of the other window images may not be adequate.

Accordingly, researches and investigations have been conducted concerning the method of preserving image data as well in the entire image display system. The present invention is completed as a result of these researches and investigations.

According to the present invention, image display characteristic data such as the contrast, the brightness and the gamma characteristic (hereinafter refereed to as “image quality data”) which have not heretofore been managed, are transmitted together with gradation data for each layer constituting an image from the image drawing unit to the image display unit. Also, the gamma correction circuit for the entire screen area is controlled by using the image quality data of the outermost layer (referred to as “first layer”), which is theoretically assumed to be closest to the screen surface, while executing image processing of the images in the other layers than the first layer such as to match the image quality layer thereof. Thus, according to the present invention means for adjusting the image display characteristic data as desired such as to match the original image data is provided on the image display unit side, permitting viewing of various original images without image quality reduction.

The present invention provides improvements in the prior art image display system as described above, in a part thereof in which the image quality data and gradation data constituting the image data coexist in a vague form and processed and transmitted in a vague form.

In the image display system according to the present invention gradation data constituting the display (i.e., image data) and image layer relation constituting the display and also image quality data in each layer, are transmitted from the image drawing unit to the image display unit, and in the image display unit a color managing mechanism of the entire image display unit is initialized from the transmitted gradation and image quality data by using the first layer image data. For the second to the n-th layers, image processing is executed in the color managing mechanism, which has been initialized with the first layer image quality data, thus obtaining display with the best reproducibility.

The embodiments of the present invention will now be described in detail with reference to the drawings.

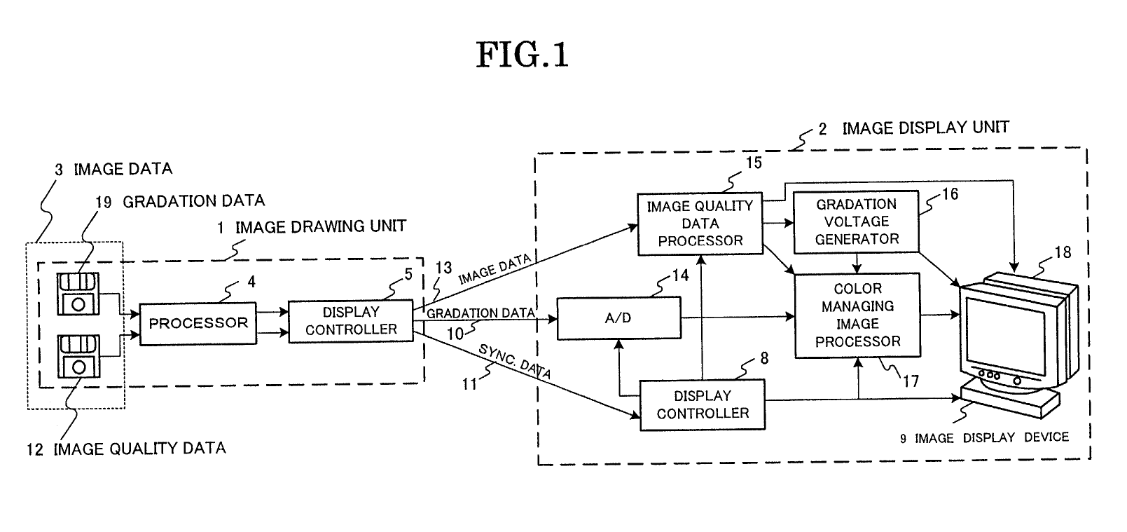

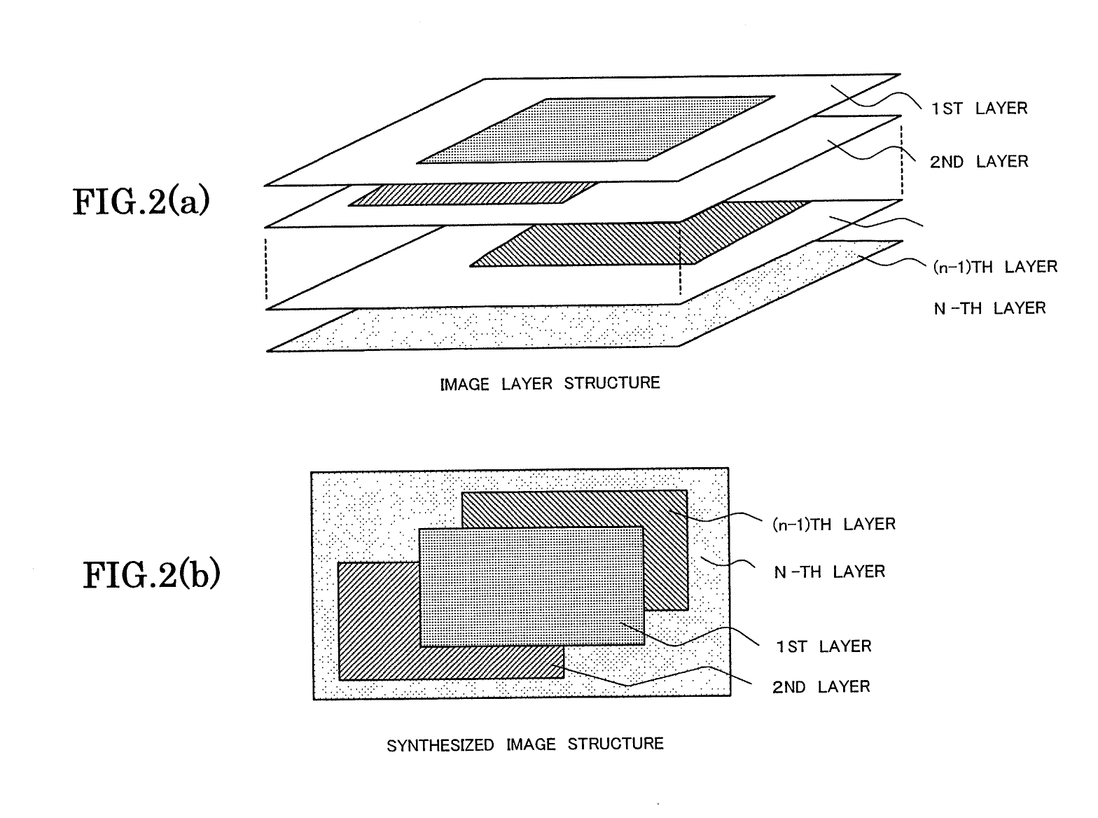

A first embodiment of the present invention will now be described with reference to FIGS. 1 and 2. FIG. 1 is a view for describing the basic construction of and the operational principle underlying the first embodiment of the present invention.

In the prior art image display system shown in FIG. 6, the image data 3 which is constituted by sole gradation data including imperfect image quality data, is dealt with as an original image. According to the present invention, as shown in FIG. 1, the image data 3 one original image is defied separately by using gradation data 19 constituted by sole gradations and image quality data 3 representing the image quality, which is assumed by the person generating the image data 3 at the time of the generation. Where image data 3 of a number of images are present, the image data of each image is likewise defined separately as the gradation data 19 and the image quality data 12.

At this time, the image quality data 12 in the image data 3 of each image may not be integrated with the gradation data 19, and the two different data may be extracted from separate files or data bases and combined.

As schematically shown in FIGS. 2(a) and 2(b), in a present computer system or the like, a 1-st to an n-th layers are formed as imaginary display areas (see FIG. 2(a)) on a display screen, and by allotting an application to a particular rectangular area of each layer to the 1-st to n-th layers are displayed by overlap combining them through the image processor and the display controller 5 (see FIG. 2(b)).

The images that are displayed in the 1-st to the n-th layers are drawn by separate applications (sometimes a number of layers are dealt with by the same application), and the image quality data such as the gamma characteristic assumed for the individual images may vary with the images.

In the reproduction of the images in the image display unit 2, the order of layers is important. Methods of transmitting layer order data from the image drawing unit 1 to the image display unit 2 may be:

one in which the currently selected active image is dealt with as 1-st layer and the next inner layer as 2-nd layer and so forth; and

one in which layer order number data is added as image quality data so as to transmit the layer order data of each layer from the image drawing unit 1 to the image display unit 2. According to the present invention it is possible to adopt either of these methods.

The display controller 5 sends out the gradation data of the synthesized image to the gradation data transmitting communication cable line 10, and sends out sync data necessary for the image display to the communication cable line 11.

Also, the image data of the 1-st to the n-th layers are sent out together with added effective display position data for each layer via the image data transmitting communication cable line 11 to the image display unit 2.

As the image display device 9 in the image display unit 2, it is possible to use various devices. In the description of one embodiment of the present invention, a flat panel display such as a liquid crystal display (LCD) is assumed as the image display device.

In the construction shown in FIG. 1, it is assumed that the video output from the display controller 5 is an analog signal. Thus, when using a liquid crystal display as the image display device 9, the input analog signal is usually converted in an A/D converter 14 to a digital signal to obtain digital gradation data.

As for the image quality data representing the gamma characteristic, the contrast, the brightness, the effective image area, etc. of each of the 1-st to the n-th layers, the display controller 5 sends out the data via an image quality data transmitting communication cable line 13 to an image quality data processor 15 in the image display unit 2.

The image quality data processor 15 executes a process of converting the characteristics of the image display device 9 on the basis of the input image quality data of each layer.

In one embodiment of the present invention, as the image quality data are transmitted data concerning the layer structure, the gamma characteristic, the contrast, the brightness, the effective image area, etc. of the original image.

Where the image data of a number of layers is transmitted from the image drawing unit 1, it is thought that the user's attention is given to the outermost layer image. Thus, the image quality data processor 15 converts the gamma characteristic, contrast and like data concerning the driving of the liquid crystal element of the liquid display as the image display device 9 on the basis of the outermost layer image data to gradation voltage data given to a liquid crystal driver, and also controls data concerning the display brightness to the light intensity of light emitted from a back light disposed behind the liquid crystal display.

The images other than the outermost layer image are not always given the user's attention, and thus they may be expressed without any problem as images as close to the original images as possible.

The image quality data of the layers other than the outermost layer are fed together with the outermost layer image quality data to a color managing image processor 17 for image processing on the basis of the outermost layer image quality data such as to reduce error in the display on the image display device 9, in which parameter optimization is made.

The color managing image processor 17 thus executes an image processing on the image gradation data from the A/D converter 14 on the basis of the 1-st layer, and generates, for data display on the image display device 9, actual drive voltages by multiplying the processed data by gradation voltages obtained from a gradation voltage generator 16.

At this time, the image quality data may be given in units of displayed dots, units of lines or units of frames. The present invention is applicable to any of these cases, because the video data of the original image is separated into the gradation component and the image quality component, and is reconstituted to the actual image on the side of the image display unit 2.

As has been shown, according to the present invention the image quality of active images can be perfectly preserved even in the window display of a number of applications on a common display screen. Thus, it is possible to give the image quality of the original image to the image display device faithfully and without spoiling and enhance the image reproducibility.

Also, while in the above embodiment the layer structure data, the effective image position data, and the image gamma characteristic, contrast data and brightness of the image are described as image data transmitted from the image drawing unit 1 to the image display unit 2, it is possible to add further image quality data such as parameter data concerning the display colors. Furthermore, it is possible to dispense with some of the image quality data, and in this case it is also possible to obtain the effects obtainable by separating the original image into the gradation component and the image quality component for transmission from the image drawing unit to the image display unit.

Still further, while in the above first embodiment the image quality data is transmitted from the display controller 5 to the image display unit 2, it may not necessarily be transmitted from the display controller 5. For example, the same effects of the present invention may also be obtained by transmitting the image quality data from the display controller 4 via a branch line separate from the gradation data cable line 10 to the image display unit 2.

Yet further, while in the above embodiment the transmitted image quality data is described to be an analog signal, it is also possible to transmit digital gradation data from the image drawing unit 1 to the image display unit 2. In this case, the A/D converter in the image display unit 2 may be dispensed with. According to the present invention, it is of course possible to adopt such a construction. Generally, the image quality data may be either analog signal or digital signal.

Further, while in the above first embodiment the gradation data, the image quality data and the sync data are transmitted from the image drawing unit 1 via respective separate communication cable lines to the image display unit 2, either two of these three different data may be combined on the same communication cable line. As a further alternative, all the three different data may be transmitted in superimposition on one another on the same cable line. Further, the gradation data, the image quality data and the sync data may be transmitted as digital data on a time division basis or a frequency division basis or in the form or packets.

Further, as image quality data transmitting means it is possible to use an USB (Universal Serial Bus) or such existing communication lines as typically represented by IEEE1394, RS232C and RS422 standards. The radio and infrared communication systems may be employed.

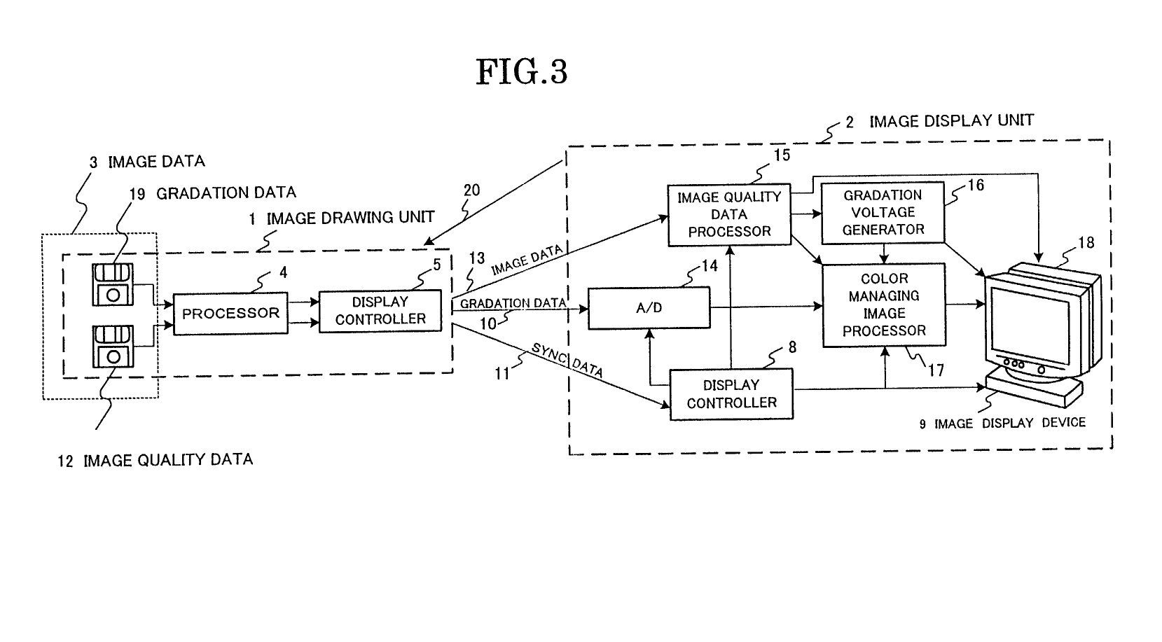

A second embodiment of the present invention will now be described. FIG. 3 is a view showing the construction of the second embodiment of the present invention. In the preceding first embodiment, the image display unit 2 receives and displays only image data transmitted from the image drawing unit 1 via the communicationcable lines. Therefore, the assumed image as presently displayed on the side of the image display unit 2 can not be known on the side of the image drawing unit 1. In some cases, this may result in a difference between preset values on the two sides.

In the second embodiment of the present invention, as shown in FIG. 3, a communication cable line 20 is provided for transmitting the operating status from image display unit 2 to image drawing unit 1, thus permitting monitoring of the operating status of the image display unit 2 on the side of the image drawing unit 1.

For example, such data as parameter data in the A/D converter 14, gamma correction data, light intensity of the back light, control status data and color management parameter data on the side of the image display unit 2, are informed via the communication cable line 20 to the operating processor 4 and the display controller 5 in the image drawing unit 1.

As shown, in the second embodiment of the present invention the image drawing unit 1 and the image display unit 2 are interconnected by bilateral communication line to permit image management by cooperation of the two units 1 and 2.

Also, in the second embodiment of the present invention, when the power source of the image display unit 2 is connected after the connection of the power source of the image drawing unit 1 or reconnected after being once disconnected, the status can be instantly informed to the unit 1. Thus, it is possible to obtain stable image display free from image quality deterioration right after the connection of the power source of the unit 2.

The second embodiment of the present invention has a further advantage that it is possible to learn user's tastes with the image drawing unit 1.

In the construction shown in FIG. 3, a signal transmitting communication cable line 20 is led from the image display unit 2 to the image drawing unit 1 separately from the communication cable lines 10, 11 and 13 led from the unit 1 to the unit 2. Alternatively, the communication cable line 20 for transmitting data from the unit 2 to the unit 1 may be replaced with an arrangement superimposing the data on the image quality data transmitting communication cable line 13, the gradation data transmitting communication cable line 10 or the sync data transmitting communication cable line 11 by a frequency multiplexing system or a time division system. As a further alternative, the wired data transmission may be replaced with radio transmission such as electromagnetic wave or infrared data transmission.

Furthermore, as the communication cable line 20 may be used such an existing communication line as those typically of the USB, IEEE1394, RS232C and RS422 standards.

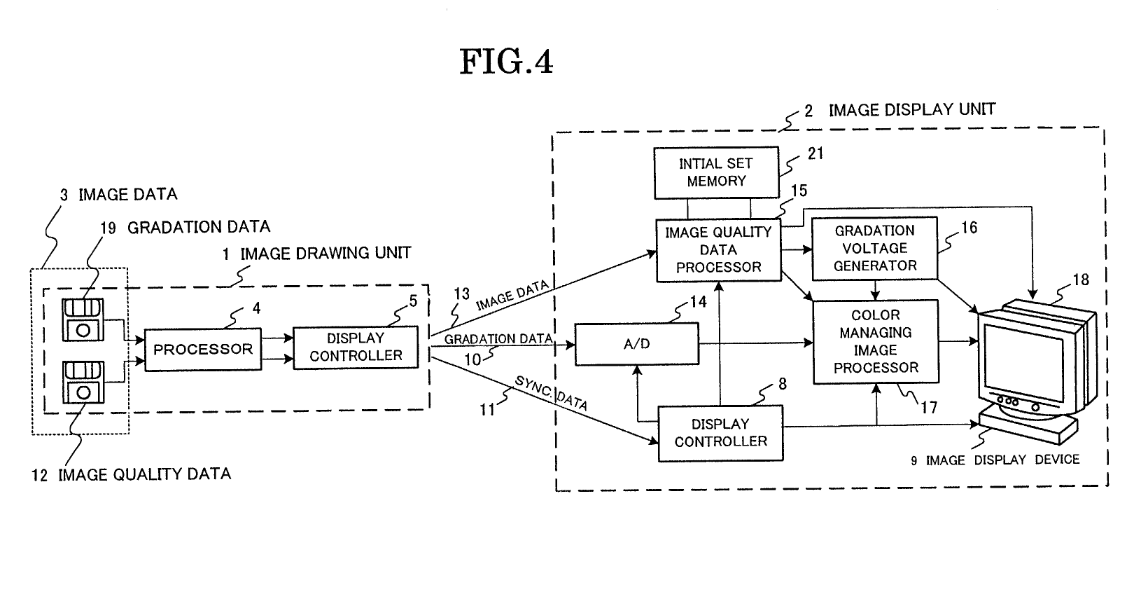

A third embodiment of the present invention will now be described. The third embodiment of the present invention features an initial preset data memory 21, which is provided in the image display unit 2 for preventing instable operation right after the connection of the image display unit 2 or at the time of resetting of the image display unit 2. FIG. 4 is a view showing the construction of the third embodiment of the present invention. Referring to the Figure, initial preset data is inputted as image data at the time of connecting the power source or at the time of resetting to the initial preset data memory 21 in the image display unit 2. The image display unit 2 usually prescribed full screen area gamma correction parameters in the gradation voltage generator 16 by using first layer image quality data in the image quality data transmitted from the image drawing unit 1.

At the power source connection time or the resetting time, it is not clear whether image quality data transmitted from the image drawing unit 1 can be received at proper timings. In some cases, normal display may fail to be obtained.

In the third embodiment of the present invention, in case when the operation may be unstable such as in the initial state, the preset parameters of the gamma correction and the color matching in the gradation voltage generator 16 and the color managing image processor 17 are set by using the image quality data recorded in the initial preset data memory 21, thus permitting normal display to be continuously obtained.

In the third embodiment of the present invention having the above construction, even in the event of the failure of image quality data transmission from the image drawing unit 1 to the data display unit 2 due to some cause, that is, even when the sole gradation data is transmitted to the unit 2, it is possible to prevent the operation from becoming unstable by setting such circuit parameters as for the gamma correction and the color matching in the gradation voltage generator 16, the color managing processor 17 and the back light 18 by using the image quality data stored in the initial preset data memory 21.

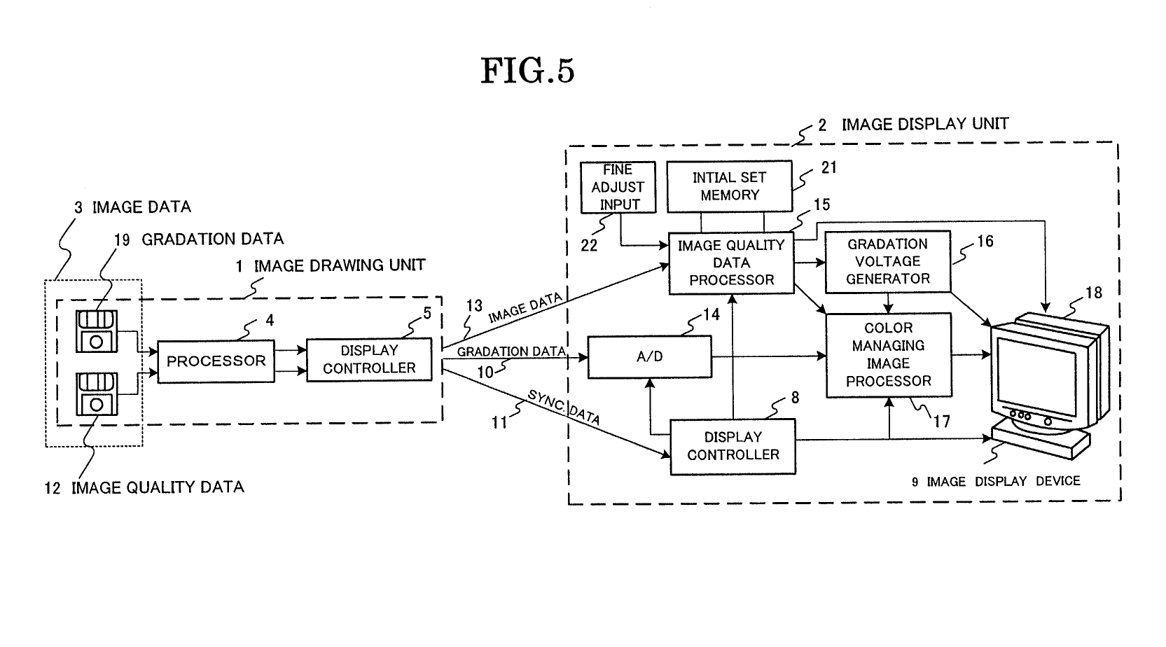

A fourth embodiment of the present invention will now be described. The fourth embodiment of the present invention has an additional function of permitting the observer unsatisfactory with the standard image quality correction to manual image quality adjustment. FIG. 5 is a view showing the construction of the fifth embodiment of the present invention. Referring to the Figure, the fourth embodiment of the present invention features a fine adjustment input unit 22 for inputting observer's tastes. The observer can store difference data from the image quality data transmitted from the image drawing unit 1 in the initial preset data memory 21.

In such fourth embodiment of the present invention, it is possible to preserve satisfactory image quality of all the layers by image processing, which is executed in the color managing image processor 17 on the virtually multi-layer image data transmitted from the image drawing unit 1 with respect to the 2-nd to the n-th layers other than the 1-st layer by using the image quality data and the correction data stored in the initial preset data memory 21.

In the above first to fourth embodiments of the present invention, the method of signal transmission from the side of the image display unit 2 to the side of the image drawing unit 1 is by no means limitative, and it is possible to adopt any signal transmitting system. For example, such transmission as radio, wired, optical cable and electric cable transmission and also superimposition transmission on various different cables may be appropriately adopted as means of communication from the side of the unit 2 to the side of the unit 1 in dependence of various applications.

Also, the image drawing unit 1 and the image display unit 2 may be spaced apart by any physical distance, either long or short. As for the packaging, the units 1 and 2 may be accommodated in the same casing or different casings. In general, the present invention is by no means limited to the particular constructions as described above.

As has been described in the foregoing, according to the present invention image data, image quality data and image configuration designation data are transmitted to the image display unit, and it is thus possible to obtain image reproduction faithful to the image quality of the original image not only in the full screen display but also in the number of different applications where the same screen area is commonly used by different images.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

What is claimed is:

1. An image display system comprising an image drawing unit and an image display unit for receiving and displaying image data transmitted from the image drawing unit, wherein:
the image drawing unit includes means for transmitting image quality data prescribing image display characteristics with respect to the image data to at least the image display unit; and
the image display unit includes means for correcting and displaying the image data on the basis of the image quality data transmitted from the image drawing unit.

2. An image display system comprising an image drawing unit and an image display unit for receiving and displaying image data transmitted from the image drawing unit, wherein:
the image drawing unit includes means for transmitting image quality data prescribing image display characteristics with respect to the image data and image condition designation data for designating the display structure to at least the image display unit; and
the image display unit includes means for correcting and displaying the image data on the basis of the image quality data transmitted from the image drawing unit.

3. The image display system according to claim 1 or 2, wherein the image drawing unit transmits gradation data constituting the image as the image data to the image display unit.

4. The image display system according to claim 1 or 2, wherein image data dealt with in the image drawing unit includes image data recorded as electronic data or image data of one or more layers generated by predetermined software.

5. An image display system comprising an image drawing unit and an image display unit for receiving and displaying image data transmitted from the image drawing unit, wherein:
the image drawing unit includes means for separating gradation data, image quality data and display condition designation data concerning images to be reconstituted and transmitting the separated gradation data and display condition designation data to the image display unit, and:
the image display unit includes means for receiving the gradation data, the image quality data and the image condition designation data and correcting and displaying the images on the basis of the received gradation data, image quality data and display condition designation data.

6. The image display system according to claim 5, wherein the image display unit includes means for informing the status of the image display unit to the image drawing unit.

7. The image display system according to claim 5 or 6, wherein the gradation data, the image quality data and the display condition designation data are transmitted via respective transmitting means provided separately from image data transmitting means, or transmits at least two different data among the gradation data, the image quality data, the display condition designation data and the image data via the same transmitting means, to the image display unit.

8. The image display system according to claim 5 to 7, wherein the display condition designation data transmitted from the image drawing unit to the image display unit includes at least data of the number and positions of windows displayed on the screen or layer data.

9. The image display system according to claim 5 or 6, wherein the image quality data transmitted from the image drawing unit to the image display unit includes at least the gamma characteristic data, the color space data or the luminance data of each layer in the display condition designation data.

10. The image display system according to claim 5 or 6, which comprises:
means for updating the gamma correction coefficient of a gamma correction circuit in the image display unit on the basis of the image quality data transmitted from the image drawing unit; and
means for correcting a gamma coefficient error by image processing when an image with image quality data different from the gamma correction coefficient preset in the gamma correction circuit is transmitted from the image drawing unit to the image display unit.

11. The image display system according to claim 5 or 6, wherein:
when image data transmitted from the image drawing unit to the image display unit is displayed by utilizing the full display area, gradation voltage data given to a gradation voltage generator is updated for display with image quality data of the image data transmitted from the image drawing unit; and
the image display unit includes means operable, when image data of a plurality of layers are transmitted from the image drawing unit to the image display unit, to generate a gradation voltage with preset gradation voltage data and execute image processing on the image data such as to minimize the error.

12. The image display system according to claim 5 or 6, wherein:
in the image display unit, gradation voltage data to be given to a gradation voltage generator provided in the image display unit is set on the basis of first layer image quality data irrespective of whether the image data displayed is of a single layer or a plurality of layer; and
the image data of the second to an n-th layer (n being an integral number greater than 2) are standardized by image processing scan with the first layer image quality data, thus suppressing the image quality deterioration.

13. The image display system according to claim 5 or 6, wherein the first layer image data transmitted from the image drawing unit to the image display unit is constituted by sole gradation data and when no image quality data is included, the display is made by using image quality data preset in an initial preset data memory in the image display unit.

14. The image display system according to claim 5 or 6, wherein the image drawing unit includes means for causing data transmission from the image drawing unit to the image display unit after making standardization of the gradation characteristics of the second to the n-th layers with the first layer image quality data, thus reducing the amounts of the image quality data and display condition designation data transmitted from the image drawing unit to the image display unit.

15. An image display system comprising means for causing transmission of display condition designation data (or “image quality data”) representing contrast, brightness, gamma characteristic, etc. together with gradation data for each image-constituting layer from an image drawing unit to an image display unit, wherein:
the correction of the full display area is controlled by using the image quality data of a theoretically outermost layer (or “first layer”) on the screen, while image processing on the images of the layers other than the first layer is done such as to match the first layer image quality data.

16. An image display system for transmitting video signal generated from image data in an image drawing unit to an image display unit, wherein:
the image drawing unit includes:
means for separating gradation data and image quality data constituting image data; and
means for transmitting the gradation data and the image quality data together with a display layer data to the image display unit; and
the image display unit includes means for determining a correction coefficient of the full display area from the received gradation data and image quality data by using data of the first layer as theoretically outermost layer on the screen, while causing image correction of the images of a second to an n-th (n being an integral number greater than 2) layer via a color managing image processing means with first layer correction coefficient data, thus suppressing image quality deterioration of the full display area.

17. The image display system according to claim 15 or 16, wherein data concerning the layer structure, the gamma characteristic, the contrast, the brightness and the effective image area are transmitted as the image quality data from the image drawing unit to the image display unit.

18. The image display system according to claim 15 or 16, which comprises:
an image quality data processor for executing a process of converting characteristics of an image display device on the basis of each layer input image quality data;
the image quality processor obtains a gradation voltage data applied to the image display device on the basis of the image quality data of the first layer as outermost layer;
image quality data of the layers other than the outermost layer are transmitted together with the outermost layer image quality data to a color managing image processor; and
the color managing image processor executes image processing on the gradation data of images with reference to the first layer, and generates a drive voltage by multiplying the processed data by gradation voltage data obtained from a gradation voltage generator for the display of the data on the image display device.

19. The image display system according to claim 15 or 16, which comprises means for transmitting operation status data from the image display unit to the image drawing unit.

20. The image display system according to claim 15 or 16, wherein:
the image display unit includes an initial preset data memory for setting initial preset data of image data at the power source connection time or at the resetting time, and prescribes gamma correction parameter on a full display area in a gradation voltage generator by using first layer image quality data in image quality data transmitted from the image drawing unit; and
when the operation is unstable such as at the power source connection time or at the resetting time, the gamma correction data and color matching mechanism parameter data are set and displayed by using image quality data recorded in the initial preset data memory.

21. The image display system according to claim 15 or 16, wherein the image display unit includes:
a fine adjustment data input circuit, in which is stored difference data obtained by comparison of image quality data transmitted from the image drawing unit with data inputted from the fine adjustment data input circuit; and
a color managing image processor for executing image processing on image data of a multi-layer configuration transmitted from the image drawing unit with respect to the second to n-th (n being an integral number greater than 2) layers other than the first layer with the transmitted image quality data and difference data stored in the initial preset data memory, whereby satisfactory image quality can be preserved for all the layers.

22. An image display system comprising means for predetermining correction coefficient data of the full display area by using data of a first layer as outermost layer on the basis of gradation data and image display characteristic data constituting image data and display-constituting layer data and executing image correction by using the first layer correction coefficient data.

23. The image display system according to claim 22, wherein the image quality data includes at least one of data concerning the layer configuration, the gamma characteristic, the contrast, the brightness and the effective image area of an original image.

24. An image display system comprising:
means for predetermining correction coefficient data of the full display area by using data of a first layer as outermost layer on the basis of gradation data and image display characteristic data constituting image data and display-constituting layer data and executing image correction by using the first layer correction coefficient data;
an image quality data processor for executing a process of converting characteristics of an image display device on the basis of image quality layer of each layer and executing conversion to a gradation voltage data given to the image display device on the basis of the outermost layer image quality data;
image quality data of the layers other than the outermost layer being transmitted together with the outermost layer image quality data to a color managing image processor, and the color managing image processor executing image processing on the gradation data of images with reference to the first layer, and generating a drive voltage for the display of data on the image display device by multiplying the processed data by gradation voltage data obtained from a gradation voltage generator.

25. The image display system according to claim 24, further comprising an initial preset data memory for setting initial preset data of image data at the power source connection time and at the resetting time, wherein
the image display unit prescribes full display area gamma correction parameter data in the gradation voltage generator by using first layer image quality data in the image quality data transmitted from the image drawing unit; and
when the operation is unstable such as at the power source connection time and at the resetting time, the gamma correction data and color matching mechanism parameter data in the gradation voltage generator and the color managing image processor are set for image display by using image quality data stored in the initial preset data memory.
